(19) United States
(12) Patent Application Publication
(10) Pub. No.: US 2003/0210286 A1
(43) Pub. Date: Nov. 13, 2003

(54) Touchpad having fine and coarse input resolution

(76) Inventors: George Gerpheide, Salt Lake City, UT (US); Brian Taylor, Sandy, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/375,917

(22) Filed: Feb. 26, 2003

Related U.S. Application Data
(60) Provisional application No. 60/359,628, filed on Feb. 26, 2002.

(51) Int. Cl. G09G 5/00

(52) U.S. Cl. 345/863

(57) ABSTRACT

A touchpad wherein the user moves a pointing object on a touchpad in an arcuate motion having a large diameter to thereby provide coarse input resolution, and moves the pointing object in a small diameter to provide fine input resolution, and wherein a direction of circular movement, either clockwise or counter clockwise, determines if an input value is increasing or decreasing.

### CROSS REFERENCE TO RELATED APPLICATIONS

This document claims priority to, and incorporates by reference all of the subject matter included in the provisional patent application filed on Feb. 26, 2002, and having serial No. 60/359,628.

### BACKGROUND OF THE INVENTION

1. Field of the Invention

This invention relates generally to touchpads used for input to portable electronic appliances. More specifically, the invention relates to a system and method for providing both fine and coarse input from the same touchpad device, and using simple gestures to provide fine and coarse control.

2. Description of Related Art

The present invention deals with several related problems. First, consider the size of portable electronic appliances. These appliances are becoming smaller and smaller in order to make them more attractive to consumers who want to be able to take these appliances wherever they go. Some portable electronic appliances are even combining more and more functionality because some consumers want fewer portable electronic appliances to carry around.

As portable electronic appliances become smaller and smaller, the ability to input data is becoming more difficult. The difficulty arises because instead of working with a small set of inputs, such as the ten digits on a mobile telephone, the input set has grown large and complex.

Consider a personal digital assistant (PDA). A PDA often has to provide a full keyboard in order to enter an alphabet. Even more difficult is the problem of having to deal with graphical interfaces. PDAs and even mobile telephones are becoming portable computers with all of the information that might be carried in a notebook computer. Furthermore, graphical interfaces present some unique challenges when providing a user interface.

The difficulties described are not unique to PDAs and mobile telephones. Even less complex devices are providing more and more functionality. Consider an MP3 audio player that enables a user to list items such as songs, and then move through that list in order to select a song to play, or to move to a playlist.

One feature of these portable electronic appliances that is common to all of those listed above, and other appliances under development, is the need to quickly and easily move or scroll through lists and make selections. With a desktop or notebook computer, the user might use a scroll button on a mouse, or use a scrolling zone on a touchpad. It should be noted that all of the portable electronic appliances listed above have or will soon have touchpads disposed somewhere on or within the appliances. This evolution is only natural considering the complex functions and graphical interfaces that they use. However, these portable electronic appliances presently lack a means for providing better control when scrolling through lists.

Thus, it would be an improvement over the prior art to provide a system and method for providing coarse and fine control when scrolling through a list on a portable electronic appliance.

When considering how to provide this coarse and fine control, it should be realized that an important issue to consider is the size, or range, of the list that must be controlled. For example, it may be desirable to control a portable electronic appliance where the lists are very large, and it may be advantageous to move quickly and slowly, but using the same device.

A good analogy to this situation is tuning a radio that has a wide dynamic range. A radio typically has a simple hand operated control. Tuning a radio to frequency 0.1 MHz over an entire range of 20 MHz is to control to 1 part in 200. Using a single-turn “knob” or potentiometer, a single turn or revolution of the knob changes the frequency setting from a minimum of 85 MHz to maximum of 105 MHz. Thus, it becomes obvious why it is very hard to get the “fine” control that is necessary to dial into 0.1 MHz resolution.

Prior art solutions for this problem have included a multi-turn potentiometer or knob. In this scenario, the knob can be turned multiple revolutions where one revolution might be equal to 2 MHz. In this way, it becomes much easier to dial in 0.1 MHz resolution (i.e., 0.1/2.0 => 1/20th revolution). But now a new problem has arisen. In order to move over the entire frequency range of 20 MHz will now require ten complete turns of the knob, which becomes annoyingly slow. Interestingly, this solution is what most radios and many industrial controls do.

Another prior art solution is to provide two knobs. One knob is for coarse control, and the other knob is for fine control. This solution is apparently common for industrial or laboratory equipment, but it is rare for consumer devices. This disparity is a good example of the fact that it is not user friendly to provide more controls.

Thus, the problem becomes one of being able to provide the ability to move quickly over the entire dynamic range in a single turn, while at the same time being able to easily change an operating mode to thereby quickly change to a fine tune mode and thus dial-in to a fine resolution.

Accordingly, what is needed is a system and method for providing input using a touchpad where the manner in which a pointing object touches the touchpad enables fine or coarse input, without having to resort to other mechanisms for changing the resolution of input.

The present invention solves more than just the problem of list scrolling. The present invention can be applied to controls that are used in any type of system that can receive input from an electronic or mechanical knob. In other words, the present invention does more than scroll through lists. If a system can be coupled to a touchpad, that same touchpad can provide coarse or fine input that is presently provided through knobs. Thus, what is needed is a system and method for providing touchpad input to any system that utilizes mechanical devices such as knobs or sliding actuators to provide analog input. What is also needed is a system and method for providing electronic devices with input that can be analogized to the turning of knobs or other similar actuators.

### BRIEF SUMMARY OF THE INVENTION

It is an object of the present invention to provide a touchpad having both fine and coarse input resolution.

It is another object to provide a touchpad having fine and coarse input resolution that does not require touching a particular area or region of the touchpad in order to provide this functionality.

It is another object to provide a touchpad having fine and coarse input resolution wherein the method can be implemented in software, firmware, or hardware.

It is another object to provide a touchpad having fine and coarse input resolution wherein the gestures that must be performed by the pointing object for coarse and fine resolution are similar.

It is another object to provide a touchpad having fine and coarse input resolution wherein the gestures can be performed by separate touchdowns on the touchpad.

It is another object to provide a touchpad having fine and coarse input resolution wherein the gestures can be performed in an uninterrupted motion of the pointing object.

It is another object to provide a touchpad having fine and coarse input resolution wherein the gestures can be distinguished from each other by motion in opposite directions.

It is another object to provide a touchpad having fine and coarse input resolution wherein the system utilizes speed of movement of the pointing object to control fine and coarse input resolution.

It is another object to provide a touchpad having fine and coarse input resolution wherein the system utilizes the radius of the gestures to determine if a fine or coarse input operation is being performed.

It is another object to provide a touchpad having fine and coarse input resolution wherein the direction of movement can also be used to determine the direction of movement within a list, or increasing and decreasing of values.

It is another object to provide a touchpad having fine and coarse input resolution wherein an overlay can be utilized to guide a user to perform correct gestures.

It is another object to provide a touchpad having fine and coarse input resolution wherein printing on or texturing of the touchpad can be used to guide a user to perform correct gestures.

In a preferred embodiment, the present invention is a touchpad wherein the user moves a pointing object on the touchpad surface in a circular motion having a large diameter to thereby provide coarse input resolution, and moves the pointing object in a small diameter to provide fine input resolution, and wherein a direction of circular movement, either clockwise or counter clockwise, determines if an input value is increasing or decreasing.

In a first aspect of the invention, the touchpad is providing coarse and fine input values that are increasing or decreasing numerical values.

In a second aspect of the invention, the touchpad is providing coarse and fine input values that cause a list to scroll forward or backwards.

In a third aspect of the invention, the touchpad is providing coarse and fine input values that are interpreted as increasing or decreasing in whatever units are appropriate for the device receiving the input.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a flowchart of the basic algorithm of the present invention.

FIG. 2 is a top elevational view of a touchpad illustrating one embodiment of the present invention.

FIG. 3 is a top elevational view of a touchpad illustrating a different embodiment of the present invention.

FIG. 4 is a top elevational view of a touchpad illustrating a different embodiment of the present invention.

FIG. 5 is a top elevational view of a touchpad illustrating a different embodiment of the present invention.

FIG. 6 is a top elevational view of a touchpad illustrating a different embodiment of the present invention.

FIG. 7 is a top elevational view of a touchpad illustrating a different embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a system and method for using a touchpad to provide coarse and fine user control over movement through a list being displayed on a display device. The present invention can be used in portable electronic appliances, and also in more stationary devices such as desktop computers or industrial equipment. Portable electronic appliances should be considered to include PDAs, mobile telephones, notebook computers, audio playback devices such as MP3 music players, and other similar devices that can display a list of items.

The touchpad in which this coarse and fine user control is implemented is a product of Cirque Corporation. The nature of this touchpad needs to be explained to some degree in order to show operation of the present invention. However, it should be mentioned that the Cirque Corporation touchpad is not the only touchpad in which the present invention can be implemented. The present invention can also be implemented using touchpad technology that utilizes any capacitance-sensing, pressure sensing, infra-red, optical, and other touchpad technologies that enable determination of the location of an object that is touching or proximate to a touch-sensitive surface. Accordingly, the present invention can have wide application across many different touch-sensing platforms.

The Cirque Corporation touchpad that is used to describe implementation of the present invention is a mutual capacitance-sensing device as follows. A grid of row and columns electrodes is used to define the touch-sensitive area of the touchpad. Typically, the touchpad is a rectangular grid of approximately 16 by 12 electrodes, or 8 by 6 electrodes. Interlaced with these row and column electrodes is a single sense electrode. All position measurements are made through the sense electrode.

The Cirque Corporation touchpad measures an imbalance in electrical charge on the sense line. When no pointing object is on the touchpad, the touchpad circuitry is in a balanced state, and there is no imbalance on the sense line. When a pointing object creates imbalance because of capacitive coupling, a change in capacitance occurs on the electrodes. What is measured is the change in capacitance, but not the absolute capacitance value on the electrodes. The touchpad determines the change in capacitance by measuring the amount of charge that must be injected onto the sense line to reestablish or regain balance on the sense line.

The system above is utilized to determine the position of a finger on a touchpad as follows. This example uses row electrodes, and is repeated in the same manner for the column electrodes. The values obtained from the row and column electrode measurements determine an intersection which is the centroid of the pointing object on the touchpad.

In the first step, a first set of row electrodes are driven with a first signal, and a different but adjacent second set of row electrodes are driven with a second signal. The touchpad circuitry obtains a value from the sense line that indicates which row electrode is closest to the pointing object. However, the touchpad circuitry cannot yet determine on which side of the row electrode the pointing object is disposed, nor can the touchpad circuitry determine just how far the pointing object is located away from the electrode. Thus, the system shifts by one electrode the groups of electrodes to be driven. In other words, the electrode on one side of the groups is added, while the electrode on the opposite side of the groups is no longer driven. The new groups are then driven and a second measurement of the sense line is taken.

From these two measurements, it is possible to determine on which side of the electrode the pointing object is located, and how far away. Pointing object position determination is then performed by using an equation that compares the magnitude of the two signals measured.

The sensitivity or resolution of the Cirque Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors. What matters is that the present invention is utilizing a touchpad that has a high degree of precision. This information is used by the present invention to determine the type of gesture that is being performed on the touchpad by the pointing device. The type of gesture thus determines whether coarse or fine scrolling has been enabled.

By gesture, the present invention means that the pointing object (typically a finger), is moving in a certain recognizable pattern. Pattern detection is a function of a pattern detection algorithm that is part of the present invention.

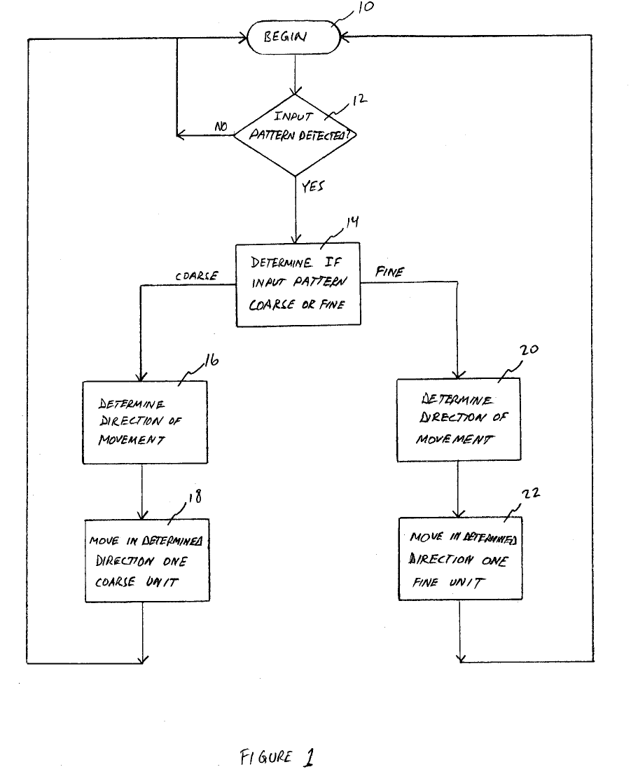

Looking at the most basic form of the present invention, it can be described as an algorithm shown in FIG. 1. It will become readily apparent that this algorithm shown in FIG. 1 can be analogized to the many different embodiments of the invention.

FIG. 1 begins with block 10. The first step in block 12 is to determine if a coarse or fine input pattern has been detected on the touchpad. In the preferred embodiment, the pattern is detected without actuation of any mode button. In other words, if a list is the active window on a display screen, for example, the touchpad will be actively looking for the pattern of the coarse or fine gesture. This situation assumes that there may be other uses of the touchpad, such as cursor control, and thus it would not be desirable to activate the scrolling function when cursor manipulation is desired.

However, it may be the case that the touchpad is being used in a very limited usage situation. For example, an MP3 player may always be in a “list mode” and pattern detection would always be active because no cursor manipulation is ever taking place.

Thus, assuming that a list is being displayed, the algorithm is looking for detection of either a coarse or fine gesture on the touchpad. If no input pattern gesture is detected, the algorithm simply keeps looking until a window with a scroll is no longer the active window, or in the case of a portable electronic appliance where a scrolling window is always active, the pattern detection algorithm continues at all times.

If the pattern is detected, the algorithm now determines whether it was a coarse gesture or a fine gesture in block 14.

If a coarse gesture is detected, block 16 determines in what direction a coarse movement should be taken in the list. The direction of movement can be thought of as “up or down”, “backwards or forwards”, “incrementing or decrementing”, or even “positive and negative”. These are arbitrary assignments that can be used as appropriate.

In block 18, the list is moved forward or backwards an arbitrary number of units that have been defined as a coarse unit. For example, if a coarse unit is defined as 20 places, the list may scroll forward or backward 20 places, depending upon the direction that the gesture indicated.

After completing the function of block 18, the algorithm returns to block 10 and begins again.

However, if the detected pattern indicated that a fine gesture was performed in block 14, then the algorithm moves to block 20.

Block 20 performs the function of block 16, but for a fine gesture.

Block 22 thus performs movement in the list of one fine unit. For practical purposes, the fine unit is most likely a single place in the list. Once completed, the algorithm then returns to block 10 to begin again.

As long as a user is performing the coarse or fine gesture on the touchpad, the algorithm will rapidly repeat its steps, thus repeatedly moving through the list forward or backward a coarse unit or a fine unit. The delay between movements of items in the list can be adjusted as desired. For example, the algorithm may be repeated once a second or twenty times a second. The number of times will be tuned to a comfortable value that is practical to work with.

It should now be apparent that the algorithm of FIG. 1 is modifiable so as to be applicable to more than just scrolling through lists. For example, instead of scrolling forward and backward through items on a list, the touchpad may be incrementing or decrementing a numerical value. For example, the algorithm could be incrementing or decrementing through available frequencies of a radio. In contrast, the touchpad may be moving forwards or backwards through the letters of a very large alphabet. Thus, the touchpad may be scrolling through items in a list, numbers, or characters that have a sequential order. What is important is that the touchpad provides coarse or fine movement through these things.

With this understanding of FIG. 1, it is necessary to discuss the coarse and fine gestures. Pattern recognition on a touchpad is possible because, as explained previously, the touchpad of the present invention has a very high degree of precision. This precision makes it possible to very quickly characterize movement on a touchpad.

The present invention defines both the coarse and fine gestures as circular or arcuate motions. Thus, while a complete circle can be used to indicate that a gesture is being performed, incomplete arcs of movement can also indicate the same information.

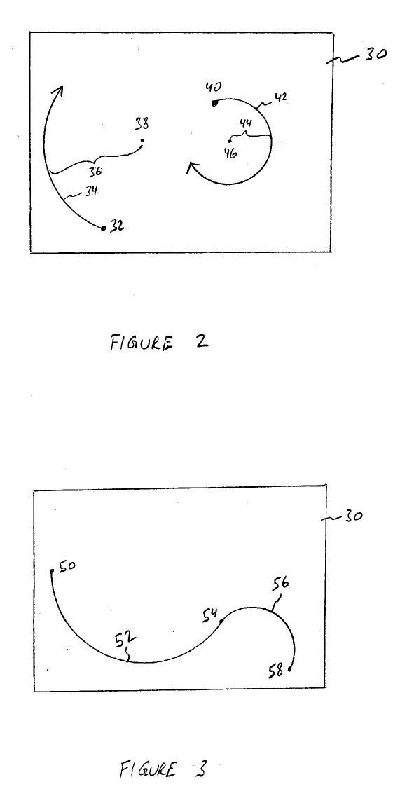

FIG. 2 is a top elevational view of a touchpad 30. A pointing device makes contact with the touchpad 30 at location 32. The pointing device then circumscribes arc 34. Arc 34 has a radius 36 around center of radius 38. In the preferred embodiment, the direction of the arc, meaning clockwise (CW) or counterclockwise (CCW), determines the direction of movement through a list, or whether a numerical value is increased or decreased. For example, arc 34 will be interpreted as a CW gesture. Assigning CW and CCW movements as “forward or backward” is completely arbitrary.

FIG. 2 also shows second arc 42 making contact with the touchpad 30 at point 40. The arc 42 circumscribes its movement around center of radius 46, having a radius 44.

The obvious difference between arcs 34 and 42 is the size of the radius. In the preferred embodiment, the size of the radius determines if the gesture is coarse or fine. Again, this assignment is arbitrary.

It should be noted that the actual movement of the pointing device is not likely to follow the very precise arcs 34 or 42. Thus, the pattern recognition algorithm used in the present invention will typically have large tolerances in order to identify the gestures accurately. Furthermore, the radius that defines the difference between a coarse gesture and a fine gesture is most likely that radius which is easiest to be larger than or smaller than. Experimentation is necessary to find a best value for the radius.

While it is an aspect of the present invention that the gestures can occur anywhere on the touchpad, there are some simple techniques that may be used in alternative embodiments so that no mistake is made.

For example, in an alternative embodiment, a coarse gesture can be arbitrarily assigned to begin on a right half of a touchpad. Likewise, the fine gesture must begin on the left half. What should be immediately recognized is that such a requirement eliminates the factor or the size of the radius in gesture determination. This raises the question of why this is not the preferred embodiment.

Another feature of the preferred embodiment is that a single continuous motion, as shown in FIG. 3, can instruct the touchpad to perform coarse and fine control. FIG. 3 is another top elevational view of a touchpad 30. The pointing device now touches down at point 50 and circumscribes arc 52. We will assume that this is a CCW coarse gesture. At point 54, the user then begins to circumscribe CW arc 56 until reaching point 58. We will assume that arc 56 is a CW fine gesture. Thus, without listing the pointing object off the touchpad surface, a user may have scrolled forward through a list in coarse mode, and then backward through the list in fine mode until reaching a desired object in the list. Movement is canceled by listing the pointing object off the touchpad 30 at point 58.

It should be explained that more than the single coarse and fine gestures shown in FIG. 3 can be coupled together in a single movement of the pointing object. For example, the pointing object could be moved CCW in a coarse gesture, then CW in a coarse gesture in a shorter arc, then moved CCW in a fine gesture in an arc of smaller radius that is below a threshold radius value, and then CW in a fine gesture until reaching a desired item on a list. All this example shows is that numerous gestures, both fine and coarse can be coupled together in a single uninterrupted motion on the touchpad.

Because of the limited surface area of the touchpad, it is not envisioned that speed of movement along an arc will not affect the speed of movement through a list, for example. Speed of movement will be a predetermined value, such as once every second, or ten times a second. Thus, it is a function of how often the gesture occurrence is being sampled.

In another alternative embodiment of the invention, the touchpad could include an overlay that makes it clear how large the radius needs to be in order to perform a coarse or a fine gesture. Thus, the pointing object can still begin the gesture anywhere on the touchpad, but at least a minimum distance from a predetermined center point.

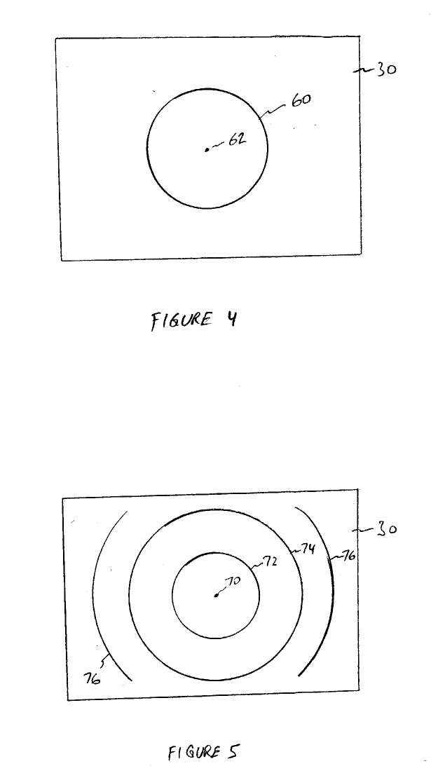

Consider FIG. 4 which is a top elevational view of touchpad 30. In this figure, circle 60 is printed on an overlay disposed on the touchpad 30. This overlay does not interfere with touchpad operation as understood by those skilled in the art.

If the pointing object is disposed on the touchpad 30 within circle 60 and begins to circumscribe an arc around center 62, then it will be assumed that one of the gestures is being performed. Likewise, if the pointing object is disposed on the touchpad 30 outside circle 60 and begins to circumscribe an arc around center 62, then it will be determined that the other gesture is being performed. Thus the user has the freedom to begin a gesture anywhere within the bounds of predefined area, but around a defined center point. It is noted that the overlay may be visual, include a texture to define the regions, or both.

It should now be apparent that if no set area is defined for the different gestures to begin, there may be some delay until the touchpad has determined that a gesture function has begun. If there is no set area, it may be possible to determine that the gesture has begun after a relatively small arc. If it is determined that a gesture is being performed, the touchpad may need to move a cursor back to the location that it had on the display screen jus before the gesture began.

In another alternative embodiment, the previous embodiments have utilized only two gesture modes, coarse and fine. Alternatively, FIG. 5 shows a top elevational view of touchpad 30. An overlay using printing, texture, or a combination of the two defines more than two circles around center point 70. A first gesture mode is enabled when circumscribing arc 72 with a pointing object. A second gesture mode is enabled when circumscribing arc 74 with the pointing object. Finally, a third gesture mode is enabled when circumscribing arc 76 with the pointing object.

Obviously, arc 76 is not shown as a complete circle on the touchpad 30 because of the physical size of the touchpad. Nevertheless, movement along any portion of arc 76 will enable the third gesture.

For example, arc 76 might be very coarse movement, thus causing large incremental steps or incremental movements through a list. Arc 74 thus defines less coarse movement, while arc 72 is the smallest incremental movement.

It should be apparent that this type of design can be carried out further, all depending upon the size of the touchpad being used. Furthermore, the arcs shown in FIG. 5 are appropriate when the pointing object is a finger. However, the arcs could be made much smaller if the pointing object was some type of stylus having a much smaller contact area that could still be used with the touchpad 30.

In another alternative embodiment, it should be understood that the present invention provides input that is not tied to directions of movement either up or down, backward or forwards, through a list. Thus, the values obtained can be interpreted to be anything desired. They might be movement commands through any type of list, numerical values of any defined size, or any other type of control that can take advantage of fine and coarse increments.

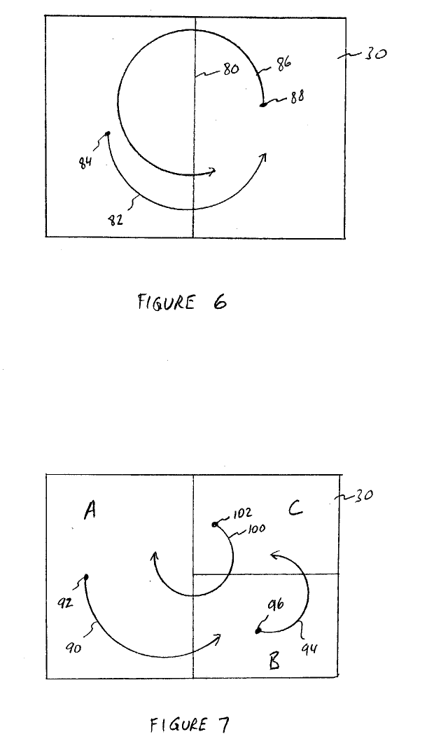

FIG. 6 is provided to illustrate the concept of dividing a touchpad 30 into separate halves. It may not even be necessary to show a division line 80 on an overlay. If the user begins to circumscribe an arc 82 with a pointing object, and begins arc 82 at point 84, then the gesture will be assumed to be coarse. Likewise, if the user begins to circumscribe an arc 86 with a pointing object, and begins arc 86 at point 88, then the gesture will be assumed to be fine. It should be understood that the assignment of gestures to a particular side of the touchpad 30 is arbitrary. Furthermore, it does not matter where the arc ends, or on which side the arc is circumscribed. What is important is where the arc begins.

FIG. 7 is provided to illustrate the concept of dividing a touchpad 30 into more than two areas. It would be necessary to describe these areas using an overlay on the touchpad 30.

If the user begins to circumscribe an arc 90 with a pointing object, and begins arc 90 at point 92 in region A, then the gesture will be assumed to be very coarse. Likewise, if the user begins to circumscribe an arc 94 with a pointing object, and begins arc 94 at point 96 in region B, then the gesture will be assumed to be less coarse. Thus, if an arc 100 begins at point 102 in region C, then the gesture will be assumed to be fine. It should be understood that the assignment of gestures to a particular region of the touchpad 30 is arbitrary.

In a final aspect of the invention, the lists being described do not have to have finite beginning or ending places. Typically, a radio knob will only turn so far, or be capable of being incremented or decremented to set values. This is not a limitation of the present invention, but could be imposed if desired. However, the ability to send a movement command or a numerical increment or decrement command can be considered as infinite in the present invention.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing input to a portable electronic appliance, wherein the input enables control of movement through a list displayed on the portable electronic appliance, said method comprising the steps of:
(1) providing a touchpad in a portable electronic appliance having a display screen, wherein the display screen is displaying a list of items;
(2) detecting touchdown of a pointing object on the touchpad;
(3) performing a pattern detection algorithm to determine if the pointing object is circumscribing an arc having a radius that is above or below a threshold radius;
(4) performing a first gesture if the pointing object is circumscribing an arc having a radius that is above the threshold radius; and
(5) performing a second gesture if the pointing object is circumscribing an arc having a radius that is below the threshold radius.

2. The method as defined in claim 1 wherein the method further comprises the steps of:
(1) performing a coarse gesture if the pointing object is circumscribing an arc having a radius that is above the threshold radius; and
(2) performing a fine gesture if the pointing object is circumscribing an arc having a radius that is below the threshold radius.

3. The method as defined in claim 1 wherein the method further comprises the steps of:
(1) performing a fine gesture if the pointing object is circumscribing an arc having a radius that is above the threshold radius; and
(2) performing a coarse gesture if the pointing object is circumscribing an arc having a radius that is below the threshold radius.

4. The method as defined in claim 1 wherein the method further comprises the step of performing the first gesture or the second gesture for as long as movement along the arc is detected.

5. The method as defined in claim 4 wherein the method further comprises the step of determining if a radius of arc changes during movement along the arc.

6. The method as defined in claim 5 wherein the method further comprises the step of changing from a first gesture to a second gesture if the radius of arc changes during movement along the arc if the first gesture was being performed, or changing from a second gesture to a first gesture if the radius of arc changes during movement along the arc if the second gesture was being performed.

7. The method as defined in claim 6 wherein the method further comprises the steps of:
(1) assigning movement through the list in a first direction when movement along an arc is in a clockwise (CW) direction; and
(2) assigning movement through the list in an opposite direction when movement along the arc is in a counter clockwise (CCW) direction.

8. A method for providing input to a portable electronic appliance, wherein the input enables control of movement through a list displayed on the portable electronic appliance, said method comprising the steps of:
(1) providing a touchpad in a portable electronic appliance having a display screen, wherein the display screen is displaying a list of items;
(2) defining a first region, and assigning a first gesture to the first region;
(3) defining a second region that includes the surface of the touchpad that is not in the first region, and assigning a second gesture to the second region;
(4) detecting touchdown of a pointing object on the touchpad in the first region or the second region;
(5) performing the first gesture if the pointing object is detected in the first region; and
(6) performing the second gesture if the pointing object is detected in the second region.

9. The method as defined in claim 8 wherein the method further comprises the steps of:
(1) only performing the first gesture as long as the pointing object remains in the first region; and
(2) only performing the second gesture as long as the pointing object remains in the second region.

10. The method as defined in claim 8 wherein the method further comprises the step of performing the first gesture or the second gesture regardless of movement of the pointing object between the first region and the second region.

11. A method for providing input to a portable electronic appliance, wherein the input enables control of movement through a list displayed on the portable electronic appliance, said method comprising the steps of:
(1) providing a touchpad in a portable electronic appliance having a display screen, wherein the display screen is displaying a list of items;
(2) defining a first radius around a center point, and assigning a first gesture to the first radius;
(3) defining a second radius that is larger than the first radius and also centered around the center point, and assigning a second gesture to the second radius;
(4) detecting touchdown of a pointing object on the touchpad on the first radius or on the second radius;
(5) performing the first gesture if the pointing object is detected on the first radius; and
(6) performing the second gesture if the pointing object is detected on the second radius.

12. The method as defined in claim 11 wherein the method further comprises the steps of:
(1) defining a third radius that is larger than the second radius and also centered around the center point, and assigning a third gesture to the third radius;
(2) detecting touchdown of a pointing object on the touchpad on the first radius, the second radius, or the third radius; and
(3) performing the third gesture if the pointing object is detected on the third radius.

13. A method for providing input to a portable electronic appliance, wherein the input enables control of movement through a list displayed on the portable electronic appliance, said method comprising the steps of:
(1) providing a touchpad in a portable electronic appliance having a display screen, wherein the display screen is displaying a list of items;
(2) defining a plurality of unique regions on the touchpad, and assigning a unique gesture to each of the plurality of regions;
(3) detecting touchdown of a pointing object on the touchpad in one of the plurality of regions; and
(4) performing the unique gesture associated with the region in which touchdown of the pointing object was detected.

14. A method for providing input to a device, wherein the input enables coarse and fine incremental change of a value to the device, said method comprising the steps of:
(1) providing a touchpad in a device having a display screen, wherein the display screen indicates a current value of an input;
(2) defining a plurality of unique regions on the touchpad, and assigning a unique gesture to each of the plurality of regions;
(3) detecting touchdown of a pointing object on the touchpad in one of the plurality of regions; and
(4) performing the unique gesture associated with the region in which touchdown of the pointing object was detected, wherein at least one of the unique gestures is to rapidly change the current value of the input, and wherein at least another one of the unique gestures is to slowly change the current value of the input.
